(19) United States
(12) Patent Application Publication
(10) Pub. No.: US 2014/0002369 A1
(43) Pub. Date: Jan. 2, 2014

(54) LOW IMPEDANCE TOUCH SENSOR

(71) Applicant: David Brent Guard, Southhampton (GB)

(72) Inventor: David Brent Guard, Southhampton (GB)

(21) Appl. No.: 13/536,200

(22) Filed: Jun. 28, 2012

(51) Int. Cl. G06F 3/041

(52) U.S. Cl. 345/173

(57) ABSTRACT

According to one embodiment, an apparatus comprises a substrate, a touch sensor disposed on the substrate, and a conductive mesh forming portions of the touch sensor. The conductive mesh comprises a plurality of first conducting segments and a plurality of second conducting segments. The first conducting segments are electrically connected to define a closed first cell, and the second conducting segments are electrically connected to define a closed second cell. Each of the conducting segments are unbroken. The conductive mesh further defines a channel that electrically isolates the first cell from the second cell.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch sensitive display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates an example touch sensor with an example touch-sensor controller.

FIG. 2 illustrates an example configuration of a drive electrode and sense electrodes used in the example touch sensor of FIG. 1.

FIG. 3 illustrates an example conductive mesh, which in a particular embodiment, forms a portion of the example configuration of FIG. 2.

FIG. 4 illustrates a portion of the example conductive mesh of FIG. 3 defining a channel.

FIG. 5 illustrates a portion of the example conductive mesh of FIG. 3 defining a channel.

FIG. 6 is a flowchart of a method for defining a channel in the example conductive mesh of FIG. 3.

### DESCRIPTION OF EXAMPLE EMBODIMENTS

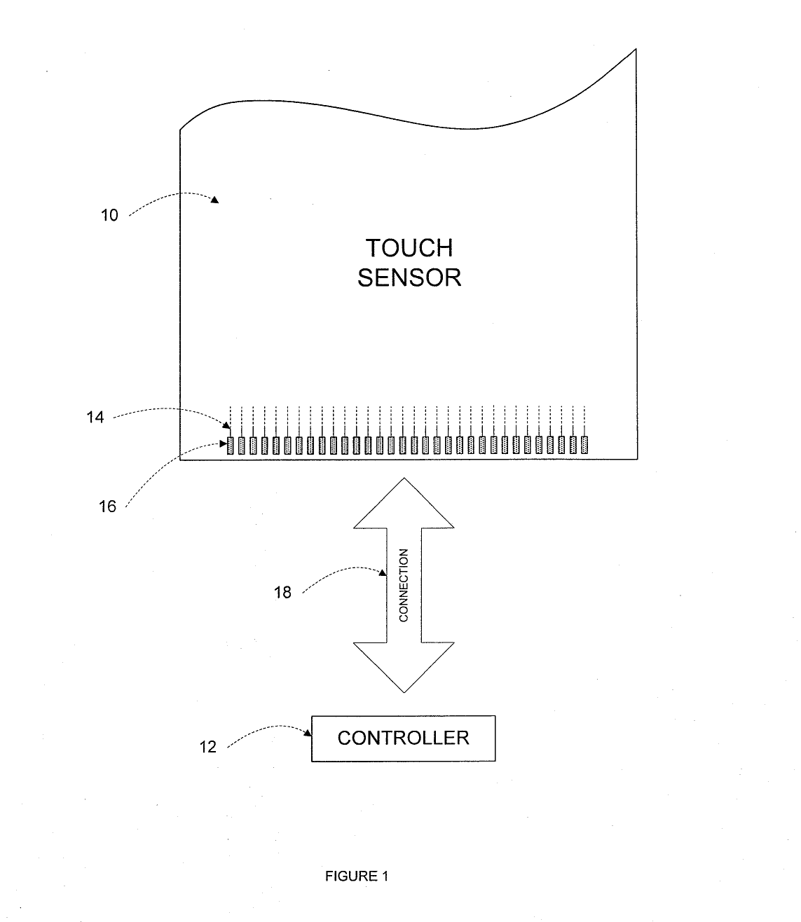

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape, where appropriate. In particular embodiments, the conductive material of an electrode may occupy substantially less than 100% (such as for example, approximately 5%) of the area of its shape. As an example and not by way of limitation, an electrode may be made of fine lines of metal or other conductive material (such as for example copper, silver, or a copper- or silver-based material) and the fine lines of conductive material may occupy substantially less than 100% (such as for example, approximately 5%) of the area of its shape in a hatched, mesh, or other suitable pattern. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns. Where appropriate, the shapes of the electrodes (or other elements) of a touch sensor may constitute in whole or in part one or more macro-features of the touch sensor. One or more macro-features of a touch sensor may determine one or more characteristics of its functionality. One or more characteristics of the implementation of those shapes (such as, for example, the conductive materials, fills, or patterns within the shapes) may constitute in whole or in part one or more micro-features of the touch sensor. One or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs) or digital signal processors (DSPs)) of a device that includes touch sensor 10 and touch-sensor controller 12, which may respond to the touch or proximity input by initiating a function of the device (or an application running on the device) associated with it. Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs)—such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. In particular embodiments, multiple touch-sensor controllers 12 are disposed on the FPC. In some embodiments, the FPC may have no touch-sensor controllers 12 disposed on it. The FPC may couple touch sensor 10 to a touch-sensor controller 12 located elsewhere, such as for example, on a printed circuit board of the device. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

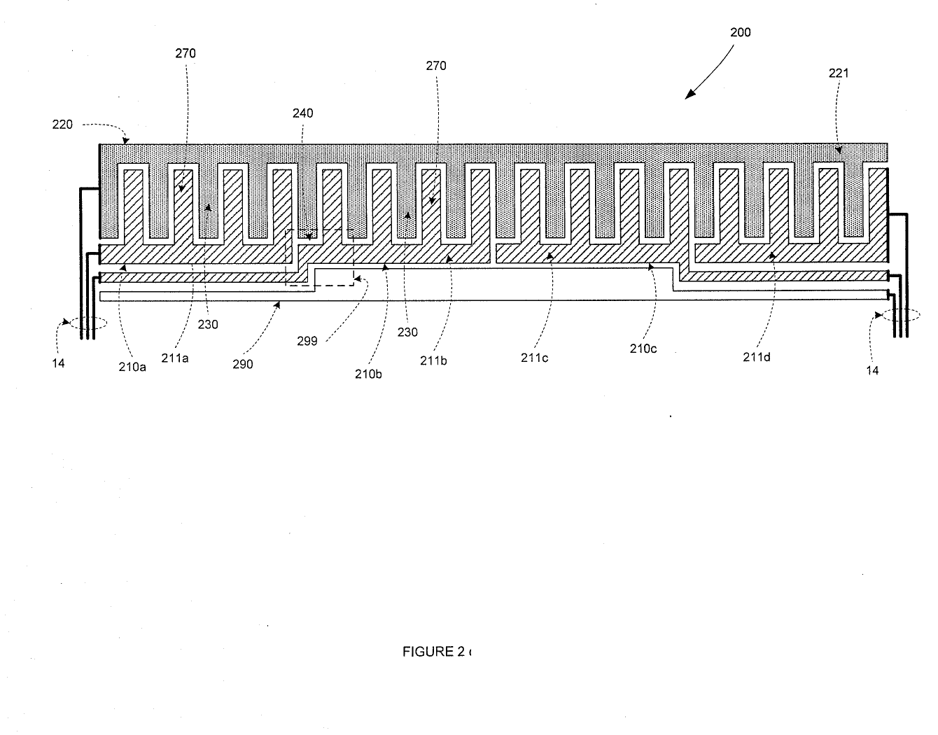

FIG. 2 illustrates an example configuration of a drive electrode and sense electrodes used in the example touch sensor of FIG. 1. As provided by FIG. 2, drive electrode 220 is interdigitated with sense electrodes 210 to form configuration 200. Configuration 200 is then coupled to a surface of a substrate to be included in touch sensor 10. In this manner, the drive electrode 220 and sense electrodes 210 occupy a single surface of the substrate thereby satisfying space and geometry constraints may be associated with the design of touch sensor 10. For example, if drive and sense electrodes had to be on different substrates, the need for two substrates would increase the thickness of the touch sensing module “stack” as compared to a stack having only one substrate.

Drive electrode 220 includes a plurality of digits 230. Each digit 230 has a particular length and width. In particular embodiments, each digit 230 is of substantially identical length and width. Each digit 230 extends from a base portion 221 of drive electrode 220 and is separated from a neighboring digit 230 by a space, a part of which is occupied by a digit 270 of a sense electrode 210. The base portion 221 of drive electrode 220 extends the length of single-layer configuration 200. Drive electrode 220 couples to a track 14.

Configuration 200 includes sense electrodes 210. In the example of FIG. 2, configuration 200 includes four sense electrodes 210a-d. Each sense electrode includes a particular number of digits 270. Each digit 270 extends from a base portion 211 of a sense electrode 210. Digits 270 occupy part of the space that separates digits 230 of drive electrode 220. The base portions 211 of sense electrodes 210 and digits 270 capacitively couple to the base portion 221 of drive electrode 220 and digits 230 across a space 240 to provide a touch/proximity sensor that, with a controller 12, can sense the location of fingers and/or objects that touch and/or in proximity to touch sensor 10. A plurality of sense electrodes 210 are configured in a pattern across single-layer configuration 200. As an example and not by way of limitation, four sense electrodes 210a-d are positioned across configuration 200. Each sense electrode 210a-d includes the same number of digits 270. The base portions of sense electrodes 210a-d are of similar lengths and are spaced evenly across configuration 200.

Sense electrodes 210 are coupled to tracks 14. Sense electrodes 210 couple to tracks 14 along the edges of configuration 200. As an example and not by way of limitation, tracks 14 for sense electrodes 210 are along the left edge of configuration 200 and the right edge of configuration 200. Sense electrodes 210 along the left side of configuration 200 such as, for example sense electrodes 210a and 210b, couple to tracks 14 along the left edge of configuration 200. Sense electrodes 210 on the right side of configuration 200 such as, for example sense electrodes 210c and 210d, couple to tracks 14 along the right edge of configuration 200. Vias or insulated bridges are used to route tracks 14 coupled to sense electrodes 210 along the top edge of configuration 200 in particular embodiments. Vias are openings made through the substrate, through which the tracks 14 can pass, so that they can continue along the opposite surface of the substrate from the electrodes. Insulated bridges are portions of dielectric or insulating material that are used at locations where a track intersects with other conductive elements to prevent direct electrical contact of the track 14 with the other conductive element.

Configuration 200 includes a ground line 290 through which drive electrodes 220 and sense electrodes 210 capacitively couple to ground. Ground line 290 couples to a track 14 along an edge of configuration 200.

In particular embodiments, by having sense electrodes 210 similarly shaped and evenly arranged across configuration 200, linearity of configuration 200 is preserved across configuration 200. Because each sense electrode 210 is of similar width and includes the same number of digits 270, tracks 14 for a particular sense electrode 210 is similar to tracking for another sense electrode 210. This linearity makes it easier for touch-sensor controller 12 to detect a touch or an object near touch sensor 10.

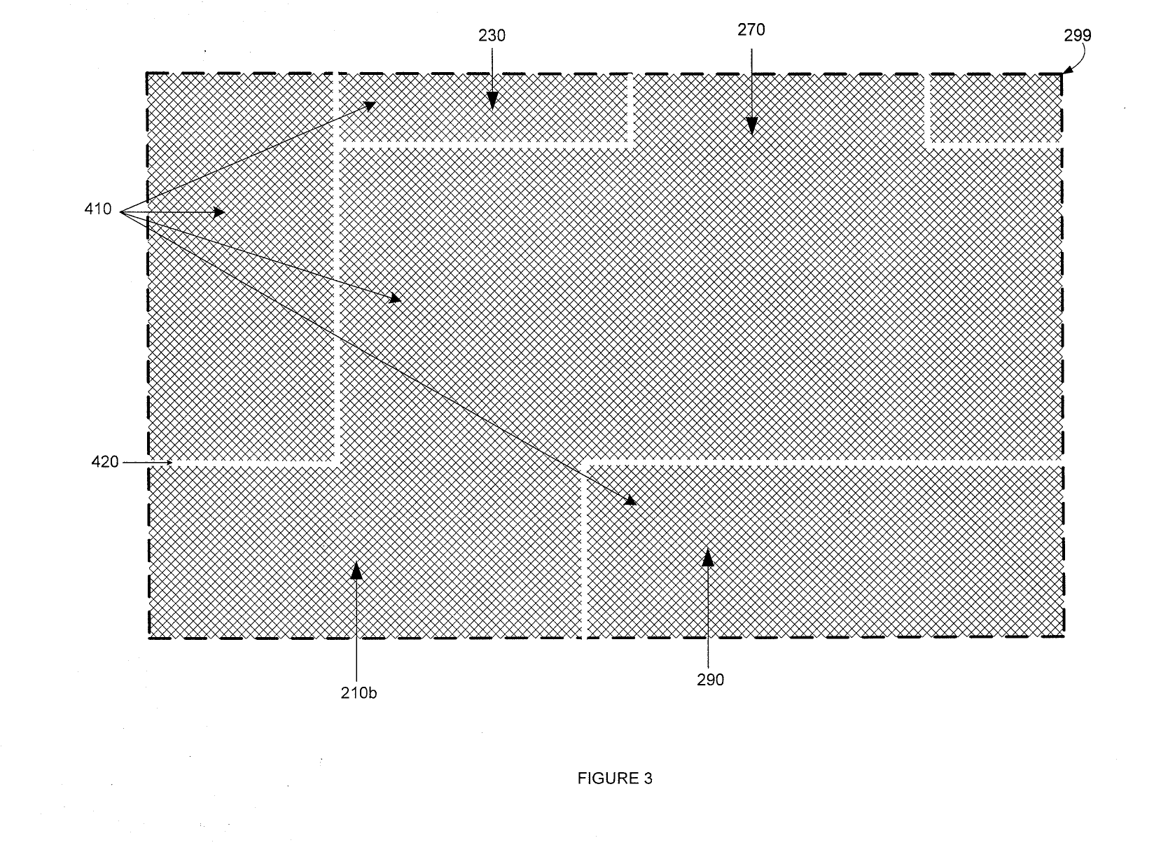

FIG. 3 illustrates an example conductive mesh 410, which in a particular embodiment, forms a portion 299 of the example configuration 200 of FIG. 2. As provided by FIG. 3, mesh 410 may define channels 420 that define the arrangement of drive electrodes 220 and sense electrodes 210 in configuration 200. In general, mesh 410 is made of a conductive material such as fine lines of metal. When no regions of mesh 410 are electrically isolated by channels 420 defined by mesh 410, electric current can flow throughout mesh 410. Channels 420 electrically isolate certain regions of mesh 410 from other regions of mesh 410. In this manner, channels 420 may be used to electrically isolate sense electrodes 210 and drive electrode 220. Electric current may then be routed through individual drive electrodes 220 and sense electrodes 210 formed in mesh 410.

Although FIG. 3 illustrates using channels 420 in mesh 410 to form a portion 299 of configuration 200, this disclosure contemplates using channels 420 in mesh 410 to form the arrangement of drive electrodes 220 and sense electrodes 210 in configuration 200.

As illustrated in FIG. 3, portion 299 includes sense electrode 210b. Channels 420 electrically isolate sense electrode 210b from other regions of mesh 410. Channels 420 also electrically isolate drive electrode 220 from other portions of mesh 210. Drive electrode 220 and sense electrodes 210 capacitively couple across channels 420.

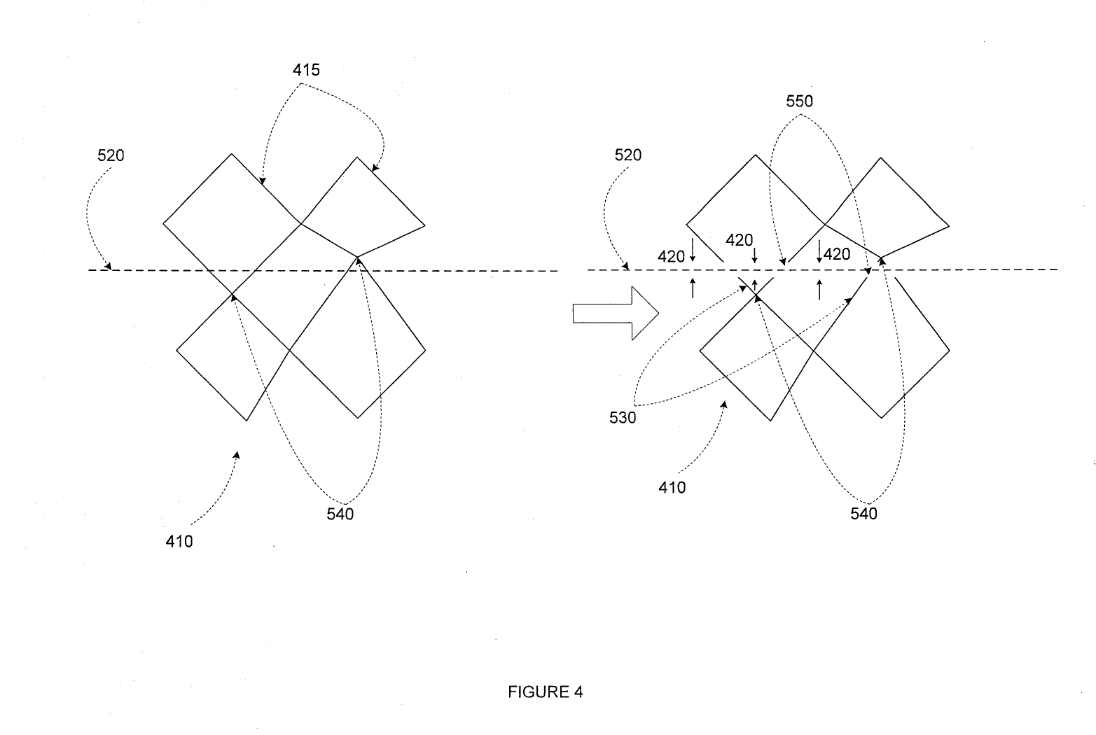

FIG. 4 illustrates a portion of the example conductive mesh of FIG. 3 defining a channel 420. As provided by FIG. 4, a portion of conductive mesh 410 is formed by conductive segments 415. Conductive segments 415 connect at particular locations, such as vertices 540, to define cells. The cells are closed shapes formed with the conductive segments 415. In particular embodiments, the cells are not uniformly shaped and sized. In other embodiments, the cells are uniformly shaped and/or sized. Conductive segments 415 facilitate the conduction of electric current throughout conductive mesh 410. However, electric current is prevented from flowing across breaks 550 in conductive segments 415 that form through intended or unintended processes. As an example and not by way of limitation, electric current may be prevented from flowing across a channel 420. Breaks 550 may be formed in conductive segments 415 along a stencil 520 such that mesh 410 defines channel 420. The stencil 520 defines a design boundary around which breaks in conductive segments 415 are formed. Stencil 520 is a guideline or tool that aids in the design of touch sensor 10. By forming breaks 550 in conductive segments 415 along stencil 520, portions of a conductive segment 415 on one side of a break 550 are electrically isolated from portions of the conductive segment 415 on the other side of the break 550.

Forming breaks 550 in conductive segments 415 has certain consequences including consequences related to optics, impedance, and reliability. By forming breaks 550 in conductive segments 415 along stencil 520, an orthogonal pattern of breaks 550 is created (e.g., particular breaks 550 lie along a line). The human eye will detect such a pattern and this detection can result in an undesirable optical artifact when one looks at touch sensor 10. Moreover, forming breaks 550 in conductive segments 415 results in broken segments 530 forming in conductive mesh 410. Electrical current does not conduct through broken segments 530 and thus broken segments 530 increase the effective impedance of conductive mesh 410. Furthermore, forming breaks 550 in conductive segments 415 makes error detection during manufacture or visual inspection difficult because breaks 550 make it difficult to tell the difference between an intended broken segment 530 and an unintended broken segment 530 (for example, one created due to a manufacturing error). When errors become difficult to detect, unintended broken segments 530 and intended broken segments 530 can form electrically isolated regions in the conductive mesh 410. If electrically isolated regions form in drive electrode 220 or sense electrodes 230, touch sensor 10 can become unreliable (e.g., unable to detect a nearby object). Furthermore, reducing the number of broken segments 530 in conductive mesh 410 increases the number of paths through which electric current may travel. These redundant paths improve the reliability of touch sensor 10 because if any breaks 550 in one path formed during regular use of touch sensor 10, an alternate path through which electric current could flow would still be available.

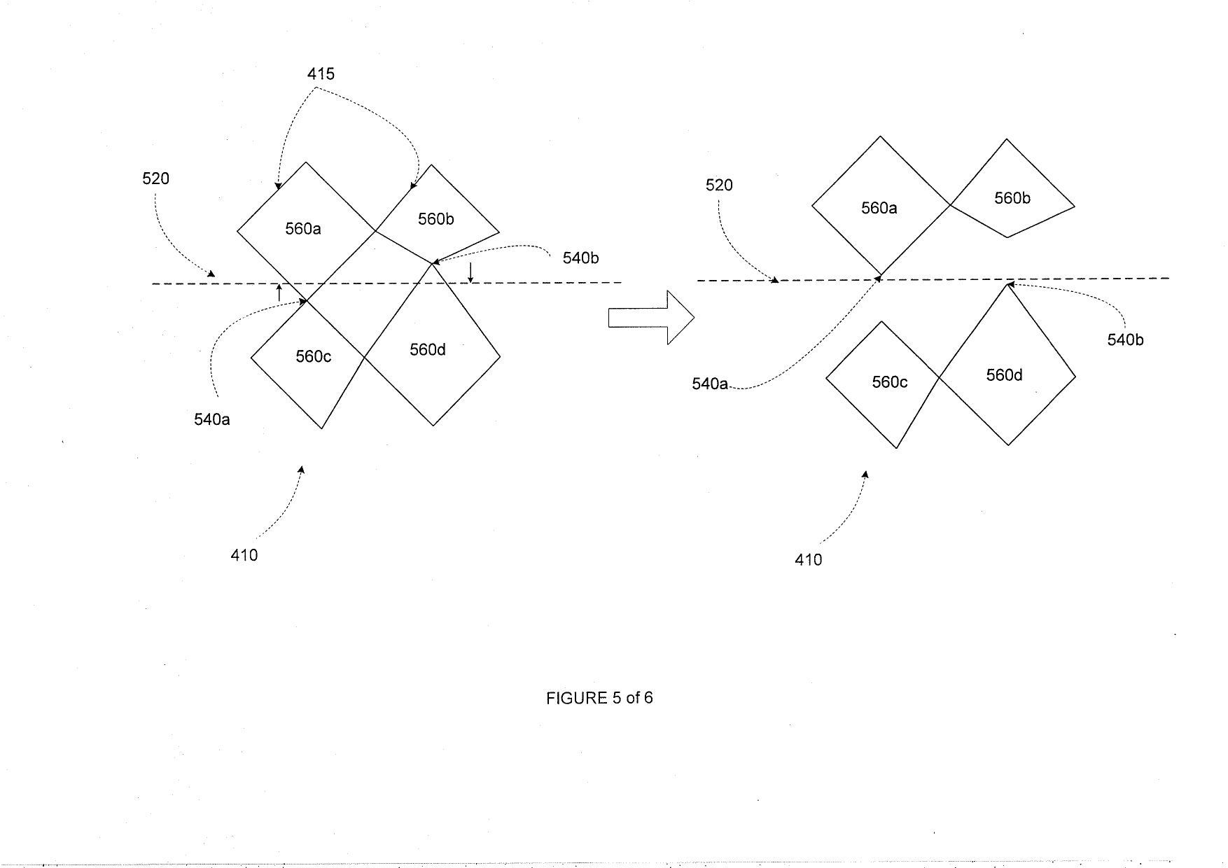

FIG. 5 illustrates a portion of the example conductive mesh 410 of FIG. 3 defining a channel 420. In the example of FIG. 5, conductive segments 415 meet at vertices 540a and 540b. Stencil 520 intersects conducting segments 415 near vertices 540a and 540b. Instead of forming breaks 550 in conducting segments 415 along stencil 520 to define channel 420, channel 420 may be defined by electrically isolating particular portions of conductive mesh 410 from other portions at points where conducting segments 415 intersect (such as at vertices 540a and 540b). As an example and not by way of limitation, cells 560a and 560b are electrically isolated from cells 560c and 560d by separating them at vertices 540a and 540b. In this manner, mesh 410 defines channel 420 along stencil 520 without breaking any conductive segments 415, thus electrically isolating adjacent cells (such as 560a and 560c) from one another without forming breaks in the conductive segments 415 that form said cells.

Cells 560a and 560b are electrically isolated from adjacent cells 560c and 560d by separating them at vertices 540a and 540b according to an algorithm in particular embodiments. The first step of the algorithm is to examine the cells along stencil 520 and to determine how to adjust them onto either side of stencil 520 to define channel 420. As an example and not by way of limitation, the algorithm examines cells 560a, 560b, 560c, and 560d and determines that cell 560a should be separated from adjacent cell 560c at vertex 540a. The algorithm adjusts the length and/or positioning of conducting segments 415 that define cell 560a around vertex 540a so that all of cell 560a is above stencil 520. In this manner, cell 560a is electrically isolated from cell 560c, and vertex 540a is moved a particular distance above stencil 520. The next step is to determine that cell 560b should be separated from cell 560d at vertex 540b. Again, the algorithm adjusts the length and/or positioning of conducting segments 415 that define cell 560d around vertex 540b so that all of cell 560b is moved a particular distance below stencil 520. In this manner, cell 560d is electrically isolated from cell 560b, and vertex 540b is moved a particular distance below stencil 520. The last step of the algorithm is to normalize the resultant distances between the vertices and stencil 520. As an example and not by way of limitation, based on the distance between vertex 540a and stencil 520, vertex 540b should be moved a particular distance from stencil 520 so that the average of the distances is a particular value. In particular embodiments, particular levels of randomness can be introduced into the distances between vertices 540a and 540b and stencil 520. In this manner, orthogonal arrangements with respect to touch sensor 10 can be reduced or eliminated thereby reducing or eliminating undesirable optical artifacts.

Electrically isolating cells 560 by separating cells 560 at vertices 540 provides improvements associated with optics, impedance, and reliability, in particular embodiments. Adjusting the length and/or position of conducting segments 415 around affected vertices 540, prevents a repeating pattern of breaks 550 from forming along stencil 520. By avoiding the repeating pattern of breaks 550, the eye will not detect any patterns thus leading to less optical distortion on touch sensor 10. Moreover, by avoiding breaks 550 in conducting segments 415, cells 560 remain closed conductive loops, thus lowering the effective impedance of conductive mesh 410. Furthermore, by avoiding any intended breaks 550 in conductive mesh 410, it becomes easier to detect errors that arise during manufacture because breaks 550 in conductive segments 415 will be unintended breaks 550. Lastly, because the only breaks 550 in conductive segments 415 are unintended breaks 550, it becomes less likely that electrically isolated regions will form in conductive mesh 410, and the number of redundant paths through which electric current can flow increases. Redundant paths improve the reliability of drive electrodes 220 and sense electrodes 230 of touch sensor 10.

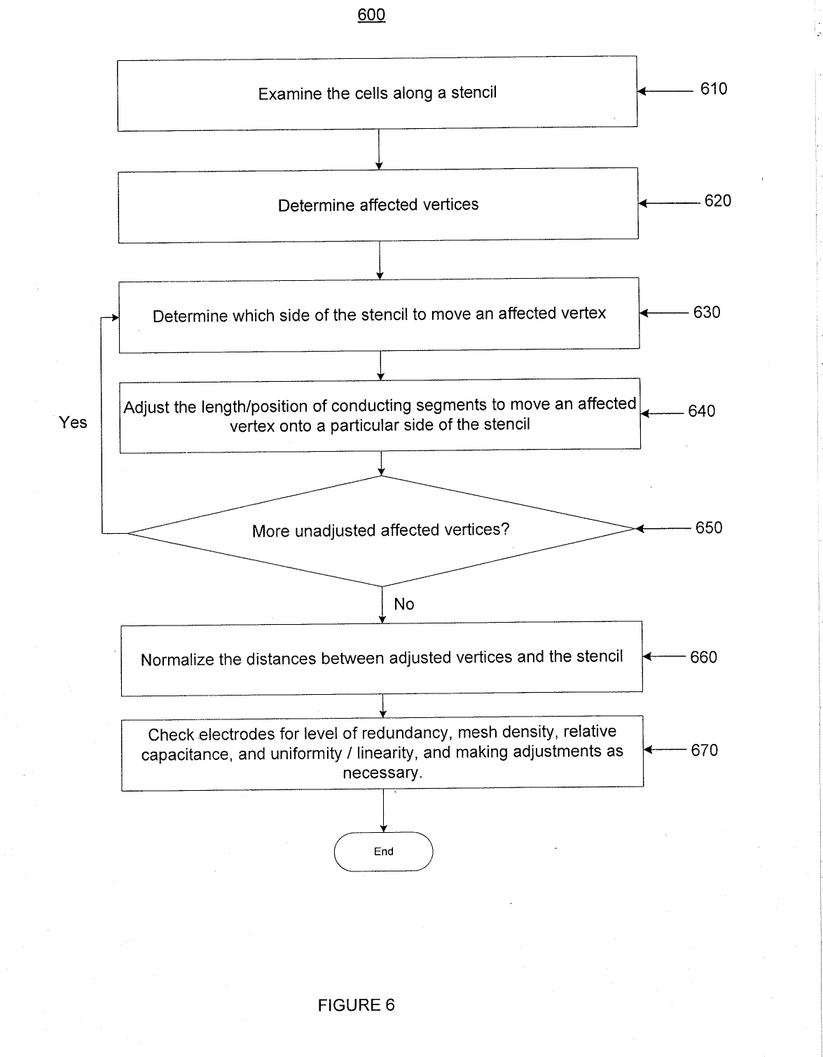

FIG. 6 is a flowchart of a method 600 for defining a channel 420 in the example conductive mesh 410 of FIG. 3. Method 600 can be executed by a computer or processor executing software or instructions stored on non-transitory, tangible computer-readable storage media. In step 610, the computer examines the cells 560 along a stencil 520. In particular embodiments, stencil 520 is generated based on the number and size of channels 420. The computer then determines the affected vertices 540 in step 620. The affected vertices 540 should be moved onto a particular side of stencil 520 in order to define channel 420. In step 630, computer determines which side of the stencil 520 to move an affected vertex 540. The computer then adjusts the length and/or position of conducting segments 415 to move an affected vertex 540 onto a particular side of the stencil 520 in step 640. In this manner, the computer electrically isolates cells 560 along the stencil 520. In step 650, the computer determines if there are any unadjusted affected vertices 540. If there are, the computer returns to step 630 to adjust the next affected vertex 540. If not, the computer normalizes the distances between adjusted vertices 540 and the stencil 520 in step 660. The computer can conclude by checking electrodes formed in mesh 410 for level of redundancy, mesh density, relative capacitance, and uniformity/linearity, and making adjustments as necessary in step 670.

Although this disclosure describes configuration 200 including a particular number of drive electrodes 220 configured in a particular manner, this disclosure contemplates single-layer configuration including any suitable number of drive electrodes 220 configured in any suitable manner. Although this disclosure describes configuration 200 including a particular number of drive electrodes 220 configured with a particular number of sense electrodes 230 in a particular manner, this disclosure contemplates configuration 200 including any suitable number of drive electrodes 220 configured with any suitable number of sense electrodes 230 in any suitable manner. Although this disclosures describes configuration 200 including a particular number of sense electrodes 210, this disclosure contemplates configuration 200 including any suitable number of sense electrodes 210. Although this disclosure describes configuration 200 including a particular number of sense electrodes 210 with a particular number of digits 270 configured in a particular manner, this disclosure contemplates configuration 200 including any suitable number of sense electrodes 210 with any suitable number of digits 270 and configured in any suitable manner. Although this disclosure describes configuration 200 including a ground line 290 configured in a particular manner, this disclosure contemplates configuration 200 including a ground line 290 configured in any particular manner. Although this disclosure describes touch sensor 10 in a single-layer configuration, this disclosure contemplates touch sensor 10 in a dual-layer configuration. Although this disclosure illustrates space 240 being of a non-uniform size across configuration 200, such as for example in FIG. 2, this disclosure contemplates space 240 being of a uniform size across configuration 200.

Although this disclosure illustrates stencil 520 as a straight line, this disclosure contemplates stencil 520 being of any suitable curvature, shape, and length. For example, stencil 520 may be curved, jagged, or any appropriate configuration to form any suitable design in conductive mesh 410. Although this disclosure describes forming breaks 550 in conducting segments 415 in a particular manner, this disclosure contemplates any suitable manner of forming breaks 550 in conducting segments 415 in any suitable manner. Although this disclosure describes the algorithm normalizing the distances between the vertices 540 and the stencil 520 in a particular manner, this disclosure contemplates the algorithm determining the distances between the vertices 540 and the stencil 520 in any suitable manner. Although this disclosure describes defining channel 420 by adjusting cells 560 in a particular manner, this disclosure contemplates defining channel 420 by adjusting cells 560 in any suitable manner. Although this disclosure discloses straight conducting segments 415, this disclosure contemplates non-linear conducting segments 415, such as for example, sinusoidal and curved conducting segments 415. Although this disclosure describes the position of cells in relation to stencil 520, this disclosure contemplates the position of cells in relation to the design boundary defined by stencil 520.

Herein, being electrically isolated encompasses a first cell 560 not making direct electrical contact with a second cell 560. Electrical current flowing in the first cell 560 may still flow through other portions of the conductive mesh 410 to reach the second cell 560.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a secure digital card, a secure digital drive, or another suitable computer-readable storage medium or a combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. An apparatus comprising:
a substrate;
a touch sensor disposed on the substrate; and
a conductive mesh forming portions of the touch sensor, the conductive mesh comprising:
a plurality of first conducting segments, wherein:
the plurality of first conducting segments are electrically connected to define a first cell;
the first cell is closed; and
each of the first conducting segments is unbroken; and
a plurality of second conducting segments; wherein:
the plurality of second conducting segments are electrically connected to define a second cell adjacent to the first cell;
the second cell is closed; and
each of the second conducting segments is unbroken; and
wherein the conductive mesh defines a channel that electrically isolates the first cell from the second cell; and
wherein the second cell is directly connected to a third cell at a vertex of the second cell and a vertex of the third cell; and
wherein the third cell is formed from a plurality of third conducting segments of the conductive mesh.

2. The apparatus of claim 1 wherein the plurality of first conducting segments and the plurality of second conducting segments comprise conducting segments that are sinusoidal.

3. The apparatus of claim 1 wherein the plurality of first conducting segments and the plurality of second conducting segments comprise conducting segments that are curved.

4. The apparatus of claim 1 wherein a break in at least one of the plurality of first conducting segments and plurality of second conducting segments indicates an error.

5. The apparatus of claim 1 wherein the channel is located along a design boundary.

6. The apparatus of claim 5 wherein the distance between the first cell and the design boundary and the distance between the second cell and the design boundary are normalized.

7. The apparatus of claim 5 wherein the first cell is entirely on a side of the design boundary and the second cell is entirely on the other side of the design boundary.

8. A system comprising:
a sensor element comprising a plurality of electrode elements formed from a conductive mesh, the sensor element configured to detect an object near the sensor element;
the conductive mesh defining a channel and comprising:
a plurality of first conducting segments, wherein:
the plurality of first conducting segments are electrically connected to define a first cell;
the first cell is closed; and
each of the first conducting segments is unbroken; and
a plurality of second conducting segments; wherein:
the plurality of second conducting segments are electrically connected to define a second cell adjacent to the first cell;
the second cell is closed; and
each of the second conducting segments is unbroken;
wherein the channel electrically isolates the first cell from the second cell;
wherein the second cell is directly connected to a third cell at a vertex of the second cell and a vertex of the third cell; and
wherein the third cell is formed from a plurality of third conducting segments of the conductive mesh;
a controller element; and
a plurality of track elements coupled to the plurality of electrode elements, each track element configured to conduct electric signals from the electrode elements to the controller element, wherein a portion of the electric signals are generated in response to the sensor element detecting the object.

9. The system of claim 8 wherein the plurality of first conducting segments comprise a conducting segment that is sinusoidal.

10. The system of claim 8 wherein the plurality of first conducting segments comprise a conducting segment that is curved.

11. The system of claim 8 wherein a break in at least one of the plurality of first conducting segments and the plurality of second conducting segments indicates an error.

12. The system of claim 8 wherein the channel is located along a design boundary.

13. The system of claim 12 wherein the distance between the first cell and the design boundary and the distance between the second cell and the design boundary are normalized.

14. The system of claim 12 wherein the first cell is entirely on a side of the design boundary and the second cell is entirely on the other side of the design boundary.

15. An apparatus comprising:
a conductive mesh comprising a plurality of cells, each cell defined by a plurality of unbroken conducting segments, the conductive mesh configured to facilitate the conduction of electric current; and
a channel defined by the conductive mesh, the channel separating a first cell in the plurality of cells from an adjacent second cell in the plurality of cells such that electric current cannot flow from the first cell directly to the second cell;
wherein the second cell is directly connected to a third cell of the conductive mesh at a vertex of the second cell and a vertex of the third cell.

16. The apparatus of claim 15 wherein the plurality of unbroken conducting segments comprise a sinusoidal segment.

17. The apparatus of claim 15 wherein the plurality of unbroken conducting segments comprise a curved segment.

18. The apparatus of claim 15 wherein the channel is located along a design boundary.

19. The apparatus of claim 18 wherein the distance between the first cell and the design boundary and the distance between the second cell and the design boundary are normalized.

20. The apparatus of claim 18 wherein the first cell is entirely on a side of the design boundary and the second cell is entirely on the other side of the design boundary.
